(19) United States
(12) Patent Application Publication
(10) Pub. No.: US 2026/0205325 A1
(43) Pub. Date: Jul. 16, 2026

(54) REDUCED COMPLEXITY SC-FDMA OPTIMIZED BASED ON UL EVM REQUIREMENT

(71) Applicant: QUALCOMM Incorporated, San Diego, CA (US)

(72) Inventors: Aviv REGEV, Tel Aviv (IL); Ronen SHAKED, Kfar Saba (IL); Shay LANDIS, Hod Hasharon (IL)

(21) Appl. No.: 19/023,224

(22) Filed: Jan. 15, 2025

(51) Int. Cl. H04L 25/02; H04L 27/26; H04L 43/0823

(52) U.S. Cl. CPC H04L 25/0202; H04L 27/2666; H04L 43/0823

(57) ABSTRACT

A method for wireless communication at a user equipment (UE) and related apparatus are provided. In the method, the UE receives an indication of a requested value of an error vector magnitude (EVM) for a resampling process for an input signal from a network entity. The UE further processes the input signal using the resampling process and a set of parameters to obtain a processed signal. The set of parameters is based on the requested value of the EVM. The UE then communicates the processed signal with the network entity.

### TECHNICAL FIELD

The present disclosure relates generally to communication systems and, more particularly, to signal processing and the associated signaling mechanisms in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology and future wireless communication technologies.

These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to receive, from a network entity, an indication of a requested value of an error vector magnitude (EVM) for a resampling process for an input signal; process the input signal using the resampling process and a set of parameters to obtain a processed signal, where the set of parameters is based on the requested value of the EVM; and communicate the processed signal with the network entity.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to transmit, to a UE, an indication of a requested value of an EVM for a resampling process for an input signal at the UE; communicate with the UE to identify a set of parameters associated with the resampling process; and receive a processed signal, where the processed signal is processed based on the input signal using the resampling process.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example DFT-IFFT process in a single-carrier frequency division multiple access (SC-FDMA) and an equivalent resampling process.

FIG. 5 is a diagram illustrating examples of an ideal low pass filter (LPF) and a finite impulse response (FIR) LPF in the frequency domain.

FIG. 6 is a call flow diagram illustrating a method of wireless communication in accordance with various aspects of the present disclosure.

FIG. 7 is a flowchart illustrating methods of wireless communication at a UE in accordance with various aspects of the present disclosure.

FIG. 8 is a flowchart illustrating methods of wireless communication at a UE in accordance with various aspects of the present disclosure.

FIG. 9 is a flowchart illustrating methods of wireless communication at a network entity in accordance with various aspects of the present disclosure.

FIG. 10 is a flowchart illustrating methods of wireless communication at a network entity in accordance with various aspects of the present disclosure.

FIG. 11 is a diagram illustrating an example of a hardware implementation for an example apparatus and/or UE.

FIG. 12 is a diagram illustrating an example of a hardware implementation for an example network entity.

### DETAILED DESCRIPTION

Single-carrier frequency division multiple access (SC-FDMA) is a technology used in wireless communication, such as 5G NR communication, e.g., for uplink (UL) transmissions. SC-FDMA combines the benefits of orthogonal frequency division multiplexing (OFDM) with a lower peak-to-average power ratio (PAPR), making it more power-efficient and suitable for mobile devices. Hence, SC-FDMA can be used as a scheme for UL transmission for mobile devices. In SC-FDMA, a resampling process by a factor of M/N may replace an M-point Discrete Fourier Transform (DFT) block followed by an N-point Inverse Fast Fourier Transform (IFFT). Using a resampling process to replace multiple operations represented by the DFT and IFFT operations reduces computational complexity on the user equipment (UE) by avoiding the numerous multiplication operations involved in the DFT and IFFT processes, thereby saving device power. Example aspects presented herein provide methods and apparatuses for a handshaking scheme between the UE and the base station to enable an up-sampler based DFT-S-OFDM generation to avoid, or reduce, DFT/IFFT computations at the UE transmission (Tx) side. The example aspects provide signaling mechanisms for configuring the parameters for the up-sampler, including the number of taps, the guard band size, and the beta factor (e.g., shaping parameters) of the filter. These parameters balance the complexity-accuracy and in-band/out-of-band error vector magnitudes (EVMs) of the finite impulse response (FIR) used in the up-sampler.

Various aspects relate generally to wireless communication. Some aspects more specifically relate to signal processing and the associated signaling mechanisms in wireless communication. In some examples, a UE receives an indication of a requested value of an EVM from a network entity for a resampling process for an input signal. The UE further processes the input signal using the resampling process and a set of parameters to obtain a processed signal, where the set of parameters is based on the requested value of the EVM. The UE communicates the processed signal with the network entity. In some aspects, the set of parameters may include the length of a low-pass filter (LPF) associated with the resampling process, and the length of the LPF associated with the resampling process may be based on the requested value of the EVM. In some aspects, the set of parameters may further include the length of a guard band associated with the resampling process, and the guard band may be located between a cutoff frequency and an edge of a frequency domain allocation associated with the resampling process. In some aspects, the set of parameters may further include a set of shaping parameters for the resampling process, and the set of shaping parameters may be associated with an in-band EVM and an out-of-band EVM in the resampling process.

Particular aspects of the subject matter described in this disclosure can be implemented to realize one or more of the following potential advantages. In some examples, by replacing DFT and IFFT processes with a resampling method, the described techniques eliminate numerous multiplication operations involved in the DFT-IFFT processing, thereby reducing the computational load and power consumption in mobile devices, and improving overall efficiency. In some examples, by enabling negotiation of various parameters involved in the resampling method, including the LPF tap length, the guard band size, and the shaping parameters, between the UE and the base station, the described techniques allow a balance between computational complexity and signal accuracy and ensure that the UE can operate within its resource constraints while meeting the quality condition (e.g., EVM condition) of the communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

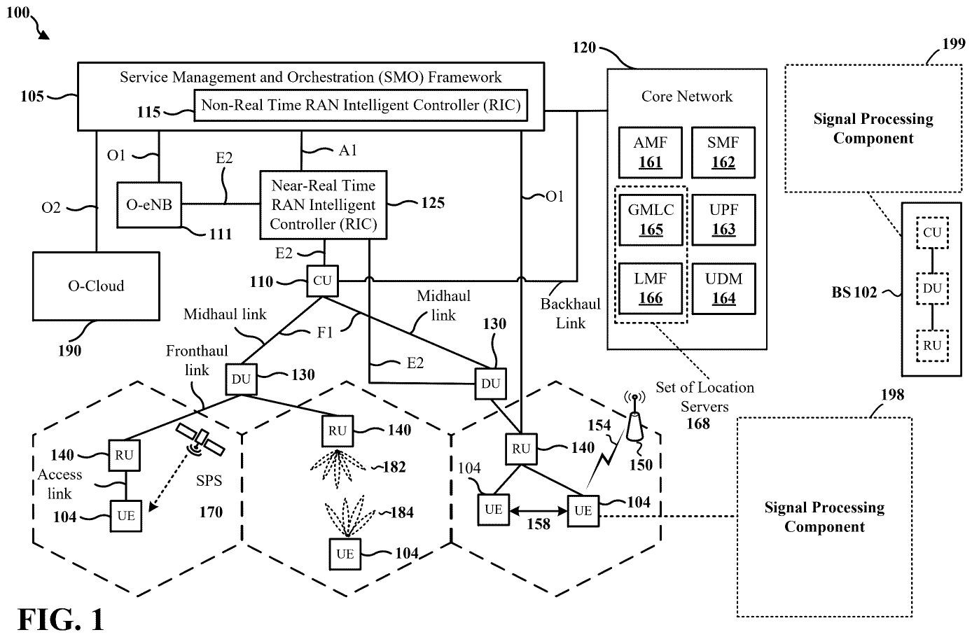

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the signal processing component 198. The signal processing component 198 may be configured to receive, from a network entity, an indication of a requested value of an EVM for a resampling process for an input signal; process the input signal using the resampling process and a set of parameters to obtain a processed signal, where the set of parameters is based on the requested value of the EVM; and communicate the processed signal with the network entity. In certain aspects, the base station 102 may include the signal processing component 199. The signal processing component 199 may be configured to transmit, to a UE, an indication of a requested value of an EVM for a resampling process for an input signal at the UE; communicate with the UE to identify a set of parameters associated with the resampling process; and receive a processed signal. The processed signal may be processed based on the input signal using the resampling process. Although the following description may be focused on 5G NR, the concepts described herein may be applicable to other similar areas, such as LTE, LTE-A, CDMA, GSM, and other wireless technologies.

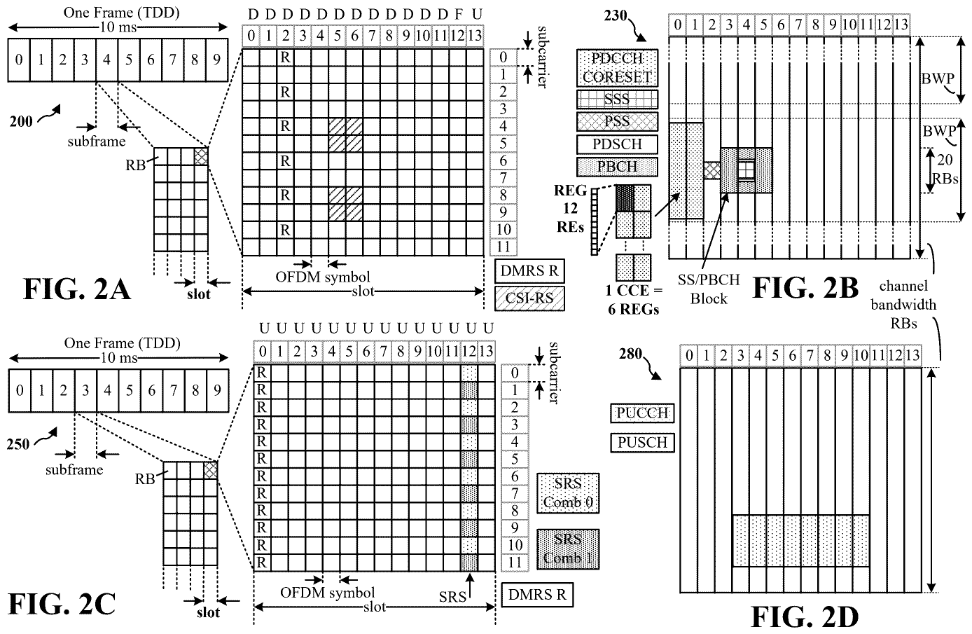

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

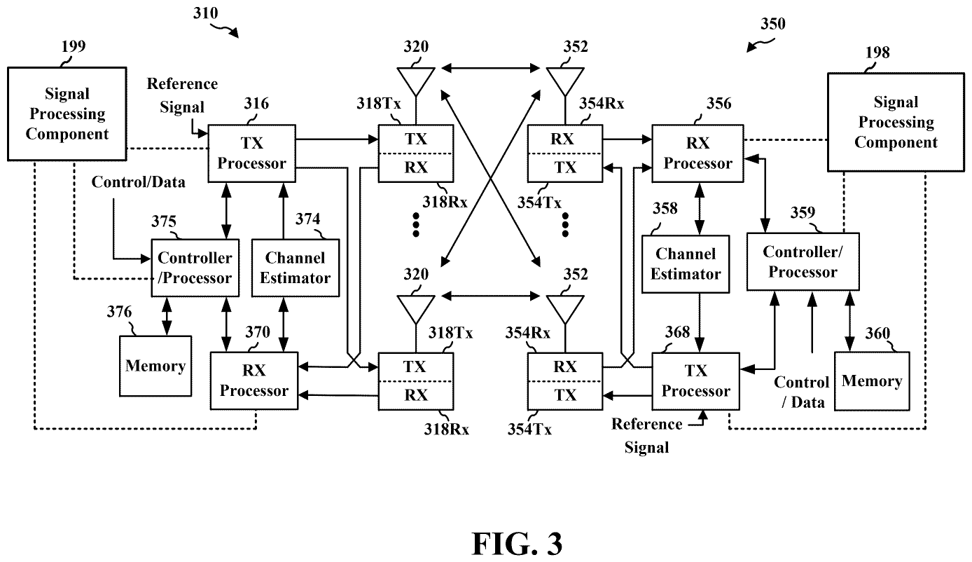

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the signal processing component 198 of FIG. 1.

At least one of the TX processor 316, the RX processor 370, and the controller/processor 375 may be configured to perform aspects in connection with the signal processing component 199 of FIG. 1.

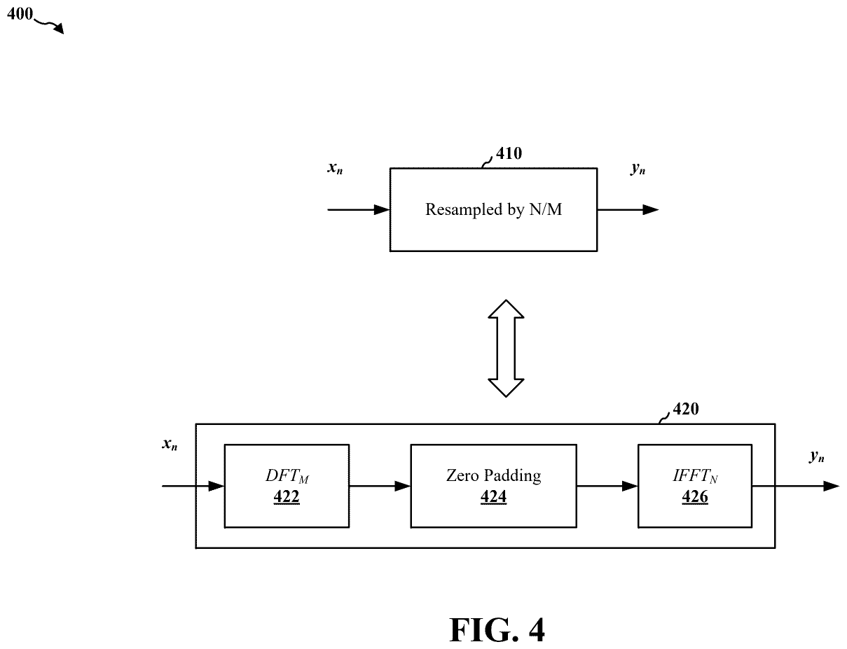

SC-FDMA is a technology used in wireless communication, such as 5G NR communication, e.g., for uplink transmissions. SC-FDMA combines the benefits of OFDM with a lower PAPR, making it more power-efficient and suitable for mobile devices. Additionally, SC-FDMA is robust against frequency-selective fading and maintains high spectral efficiency, which are advantages in modern wireless communication. Hence, in some aspects, SC-FDMA can be used as a scheme for UL transmission, while the OFDM scheme can be used for downlink (DL) transmission. FIG. 4 is a diagram 400 illustrating an example DFT-IFFT process 420 in a SC-FDMA and an equivalent resampling process 410. As shown in FIG. 4, in contrast to regular OFDM, the constellation points in SC-FDMA may pass through an M-point DFT block 422 and are zero-padded (e.g., at 424) before undergoing an N-point IFFT 426. In some examples, these three operations (e.g., 422, 424, and 426) are equivalent to a resampling process (e.g., at 410) by a factor of M/N and with an applied frequency offset. As an example, M may be 2 k and N may be 4 k, corresponding to an up-sampling factor of 2. This equivalence enables the UE, acting as a UL transmitter, to implement a resampling method (e.g., 410) in place of the three separate operations represented by the DFT and IFFT blocks (e.g., 422, 424, 426). Implementing a resampling method (e.g., 410) may reduce computational complexity by avoiding the many multiplication operations for the DFT and IFFT processes (e.g., 422 and 426), thereby saving device power.

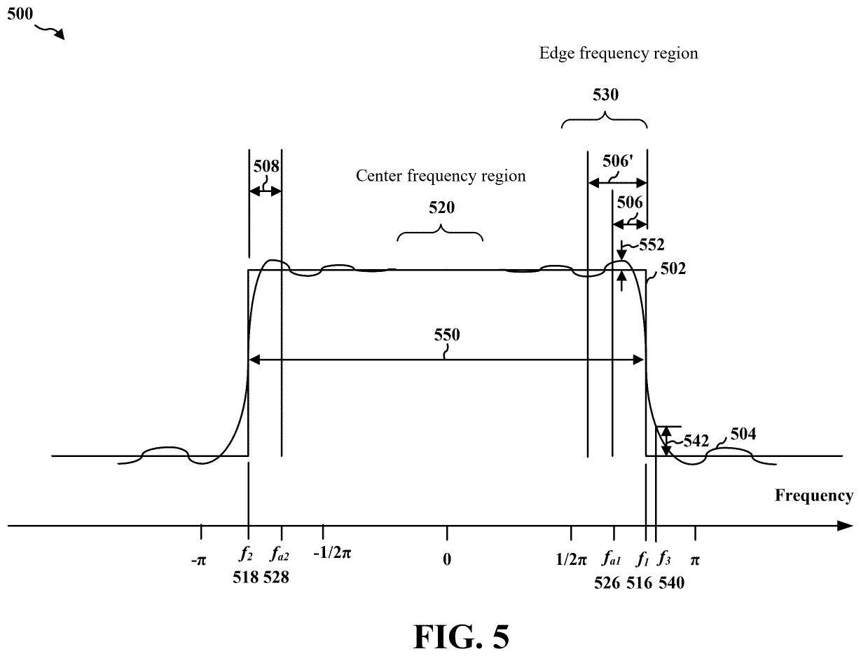

However, the resampling process involves an anti-aliasing low-pass filter (LPF) designed to reject any remaining out-of-band signals outside the desired frequency band. FIG. 5 is a diagram 500 illustrating examples of an ideal LPF and an FIR LPF in the frequency domain. As shown in FIG. 5, an FIR LPF 504 may not be ideal (compared to the ideal LPF 502), as its accuracy is determined by the number of taps the filter possesses. Due to the less-than-ideal nature of the LPF 504, resampling (e.g., 410) may introduce a manageable error when compared to the regular DFT-IFFT block method (e.g., 420). Increasing the number of LPF taps may reduce this error, but this improvement comes at the cost of increased complexity, which scales linearly with the number of taps. Hence, a tradeoff arises between UE complexity and accuracy.

Another factor that can affect the accuracy of the LPF is the configured allocation bandwidth (BW) percentage. As shown in FIG. 5, the frequency responses of a finite impulse response (FIR) filter (e.g., 504) may be designed to approximate the ideal infinite impulse response (IIR) LPF 502 as part of the resampling process. In some examples, the design of the LPF may be achieved by transforming the desired frequency domain (FD) response into the time domain (TD) and multiplying it by a finite time domain window. As an example, the time domain window may be a Kaiser window, with the shaping parameter β set to 2, and the filter may have 20 taps (N=20).

In some examples, the cutoff frequency (e.g., f₁ 510) of the LPF may be determined by the M/N ratio, which may be set to 0.8π, as an example. In some examples, the Euclidean distance between the frequency responses of the FIR filter and the ideal IIR filter is greater near the cutoff frequency. Hence, the error introduced by the FIR filter is smaller at the center frequencies, farther away from the cutoff frequency, than that near the edges of the frequency response. For example, as shown in FIG. 5, the error between the FIR LPF 504 and the ideal IIR filter (e.g., ideal LPF 502) may is smaller at the center frequency region 520 than that at the edge frequency region 530 of the frequency response. However, the error near the edges of the frequency response (e.g., at edge frequency region 530) may improve (or decrease) as the number of FIR taps (N) increases.

In some examples, to reduce the impact of the relatively large error between the FIR LPF 504 and the ideal IIR filter (e.g., ideal LPF 502) at the edge frequency region (e.g., 520), a default guard band (G) may be reserved between the cutoff frequency and the edge of the allocation. For example, referring to FIG. 5, at one edge of the frequency response, a guard band 506 may be reserved between the cutoff frequency f₁ 516 and the edge of the allocation at fₐ₁ 516. Similarly, at the other edge of the frequency response, a guard band 508 may be reserved between the cutoff frequency f₂ 518 and the edge of the allocation at fₐ₂ 528. The guard band area (e.g., 506, 508) may remain unallocated because of the anticipated high error levels in this portion of the band.

Additionally, as the guard band area widens, which corresponds to a portion of the spectrum that remains unallocated, the overall error is expected to decrease further. For example, as shown in FIG. 5, compared to guard band 506, a wider guard band 506′ may further reduce the overall error between the FIR LPF 504 and the ideal IIR filter (e.g., ideal LPF 502) in the edge frequency region 530.

Another aspect related to the LPF design involves the tradeoff between the frequency transition width and the magnitude of the ripples in the window. The tradeoff may be controlled by a set of shaping parameters. For example, when designing the finite impulse response (FIR) filter using Kaiser windowing, the set of shaping parameters that controls this tradeoff may include the Kaiser parameter β. The out-of-band error (e.g., error 542 at frequency f₃ 540), which corresponds to the stop-band attenuation, and the “near edges” error, determined by the frequency transition width of the window, may decrease as the value of β increases. However, this improvement comes at the expense of increased in-band error (e.g., error 552), which is determined by the magnitude of the ripples. On the other hand, a decrease in β leads to a reduction in in-band error (e.g., error 552) while increasing the out-of-band and near-edges errors (e.g., error 542). Table 2 shows the example of the effect of the shaping parameters (e.g., Kaiser parameter β) on in-bound error and out-of-band error.

TABLE 2
Effect of the shaping parameters on
in-bound error and out-of-bound error

| | | |
|---|---|---|
| β increases | Out-of-bound and near- | In-bound error |
| | edge error increases | decreases |
| β decreases | Out-of-bound and near- | In-bound error |
| | edge error decreases | increases |

As shown in FIG. 5, three parameters may be considered when configuring the uplink (UL) slot in an SC-FDMA scenario and implementing the lower-complexity resampling method (e.g., 410) as an alternative to the conventional DFT-IFFT process (e.g., 420). These parameters may include the length of the FIR filter (e.g., the length 550) used in resampling, denoted as N, which represents the tradeoff between computational complexity and accuracy. Another parameter is the length of the guard band (e.g., the length of guard band 506, 508), denoted as G, which balances bandwidth usage efficiency with signal accuracy. The final parameter is the window shaping parameters (e.g., the Kaiser parameter β), which balances the tradeoff between in-band error and out-of-band error in the FIR filter.

Example aspects presented herein help to optimize these three parameters through a dynamic signaling mechanism. This signaling exchange helps to account for configuration parameters, the conditions and limitations of the UE, and the conditions of other UEs that utilize adjacent bandwidth. Some example aspects presented herein provide methods and apparatuses for a handshaking scheme between the UE and the base station to enable an up-sampler (e.g., 410) based DFT-S-OFDM generation to avoid, or reduce, DFT/IFFT computations at the UE transmission side. The example aspects provide signaling mechanisms for configuring the parameters for the up-sampler (e.g., 410). The parameters may include the number of taps or the length of the FIR (e.g., N), the guard band size (e.g., G), and the shaping parameters (e.g., Kaiser parameter β) of the filter. These parameters balance the complexity-accuracy and in-band/out-of-band EVMs of the finite impulse response (FIR) used in the up-sampler.

In some aspects, the length of the filter (e.g., N) may be determined by considering the tradeoff between the UE's computational complexity and the affordable signal accuracy in uplink (UL) transmissions.

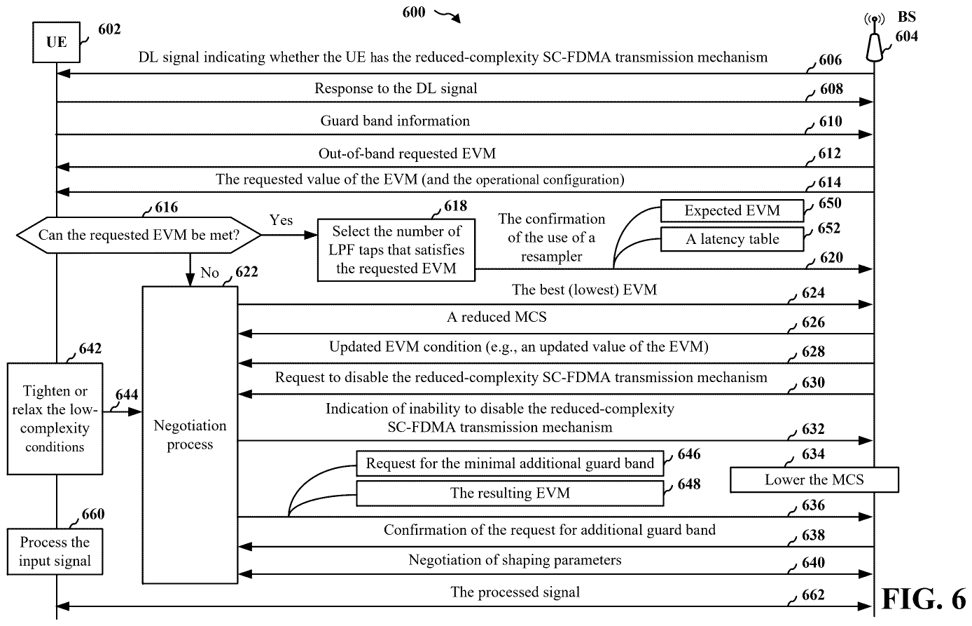

FIG. 6 is a call flow diagram 600 illustrating a method of wireless communication in accordance with various aspects of this present disclosure. Various aspects are described in connection with a UE 602 and a base station 604. The aspects may be performed by the UE 602 or the base station 604 in aggregation and/or by one or more components of a base station 604 (e.g., a CU 110, a DU 130, and/or an RU 140).

As shown in FIG. 6, in some examples, the signaling process may begin at the medium access control (MAC)-control element (MAC-CE) level with a downlink (DL) signal from the base station 604 to the UE 602 at 606, indicating whether the UE has the reduced-complexity SC-FDMA transmission mechanism (i.e., whether the UE have the capability to use the resampling process (e.g., 410) instead of the DFT-IFFT block (e.g., 420)). Upon receiving this DL signal, the UE 602 may, at 608, respond via an uplink (UL) signal at the MAC-CE level to confirm receipt of the indication request. For example, the UE 602 may, at 608, confirm that it has the reduced-complexity SC-FDMA transmission mechanism (i.e., the capability to use the resampling process (e.g., 410) instead of the DFT-IFFT block (e.g., 420)).

Subsequently, at 614, the base station 604 may send a DL signal (e.g., over the physical downlink control channel (PDCCH). The DL signal may specify the requested value of the error vector magnitude (EVM) associated with the resampling method (e.g., 410) in the current configuration. As used herein, “EVM” refers to a metric that represents the quality of a transmitted signal. A lower “EVM” indicates higher signal quality during the transmission, as it reflects less deviation between the received signal and the original signal.

For example, this requested value of the EVM may be associated with the operated modulation and coding scheme (MCS) and the thermal noise level experienced in the UL. In some examples, the UE may have a pre-examined table that maps the expected value of the EVM (e.g., in-band error) of the resampling process to the number of LPF taps. Table 3 shows the examples of the mapping between the expected values of the EVM to the number LPF taps. Each number of LPF taps may correspond to a filter length N.

TABLE 3
Example mappings between the expected values
of the EVM to the number LPF taps

| Number of Taps | EVM (dB) |
|---|---|
| 10 | −20.8 |
| 12 | −21.0 |
| 14 | −21.3 |
| 16 | −21.7 |
| 18 | −22.9 |
| 20 | −24.8 |
| 22 | −25.6 |
| 24 | −25.7 |
| 26 | −26.3 |
| 28 | −28.3 |
| 30 | −29.4 |

In some examples, the base station 604 may further transmit the operational configuration to the UE 602 (e.g., at 614 along with the requested value of the EVM). The operational configuration may include the operated MCS, the selected length of a guard band associated with the resampling process, or the selected set of shaping parameters. The operational configuration may facilitate UE 602 to process the input signal using the resampling process (e.g., at 660). For example, the UE 602 may, at 660, process the input signal using the resampling process based on the operational configuration.

The UE 602 may, at 616, determine whether the requested vale of the EVM can be met. For example, the UE 602 may make the determination based on this mapping relationship (e.g., the mapping shows in Table 3) between the EVM and the number of LPF taps and the UE capability. In some example, if the UE 602 determines, at 616, that the requested value of the EVM can be met, the UE 602 may, at 618, select the number of LPF taps that satisfies the requested EVM and, at 620, confirm that it will use a resampler via the PUCCH, for example. In some examples, the UE may include the expected EVM 650 in its response at 620. In some examples, in addition to the expected EVM 650, the UE 602 may also transmit a latency table 652 to the base station 604. In some examples, the UE 602 may provide the latency table 652 for each N value alongside the expected EVM table, as longer filters (e.g., larger N) may result in higher latency.

In some examples, if the UE 602 determines, at 616, that it cannot meet the requested value of the EVM specified by the base station 604, the UE 602 may start a negotiation process at 622 to adjust the EVM accordingly.

For example, at 624, the UE 602 may signal the best (lowest) EVM it can achieve under the current configuration (as a threshold value of the EVM) via, for example, the PUCCH. In some examples, in response to the UE's signal at 624, the base station 604 may signal, at 626, a reduced MCS level to relax the EVM condition, enabling the UE 602 to meet the revised EVM. In such cases, the base station may, at 628, communicate the updated EVM condition (e.g., an updated value of the EVM) via the PDCCH, corresponding to the new MCS configuration (e.g., reduced MCS at 626). However, in some examples, if the base station 604 declines to reduce the MCS level, it may, at 630, request the UE to disable the reduced-complexity SC-FDMA transmission mechanism and switch to the DFT-IFFT mode (e.g., 420), which offers zero error other than the fixed-point implementation limitations.

In some examples, if the UE 602 cannot comply with the high-complexity DFT-IFFT mode due to constraints such as low battery, latency requirements, or lack of implementation, the UE 602 may signal, at 632, its inability to meet the request via the PUCCH to the base station 604. In that case, the base station 604 may then lower the MCS level at 634 to continue communication. In some examples, the UE 602 may, at 642, dynamically tighten or relax its low-complexity conditions, such as during transitions in battery mode or operational latency constraints. When such changes occur (e.g., at 642), the UE 602 may, at 644, reenter the signaling and negotiation process 622 with the base station 604 to adjust the configuration appropriately.

In some aspects, the UE 602 may negotiate an additional guard band (e.g., G) with the base station 604 to improve the EVM performance in uplink transmissions. In some examples, under a fixed number of taps, the EVM improves as the guard band size increases (e.g., represented as a percentage of the guard band to the total bandwidth). In some examples, a higher improvement rate may be achieved as the number of LPF taps increases.

In some aspects, as shown in FIG. 6, the UE 602 may request an additional guard band as part of the negotiation process 622 when it cannot meet the EVM condition specified (e.g., at 614) by the base station 604. In some examples, the UE 602 may, at 636, request the minimal additional guard band 646 necessary to achieve the informed EVM condition (e.g., the requested value of the EVM at 614). In some examples, the UE 602 may, at 636, signal the resulting EVM 648 for various guard band sizes or for each additional guard band. In some examples, the UE 602 may, at 610, send the guard band information over the MAC-CE to the base station 604 at the start of communication for future uses. For example, the guard band information may include the resulting EVM values for combinations of guard band sizes and LPF tap numbers.

In some aspects, the base station 604 may accept the UE's request for additional guard band if the resulting improved EVM demonstrates higher spectral efficiency than the current default guard band configuration. In this case, the base station 604 may, at 638, confirm the request of the UE 602 via a downlink signal over the PDCCH, for example. In some examples, the UE 602 may consider its own additional constraints, such as latency, and the conditions of other UEs operating within adjacent bandwidths, in accordance with its internal policies.

In some aspects, the UE 602 may negotiate the shaping parameters of the filter (e.g., the parameter β) with the base station 604 to improve the performance of the resampler (e.g., 410). In some examples, the shaping parameters (e.g., parameter β) may be chosen to correspond to the best resulting EVM for each combination of guard band size (e.g., G) and filter length (e.g., N). In some examples, if the Kaiser window-based method is used for filter design, the shaping parameters may include a single shaping parameter β. In some examples, individual UEs may signal their own shaping parameters based on their specific implementations.

In some aspects, in addition to in-band error (e.g., 552), the out-of-band error (e.g., stop-band attenuation) may also be considered for maintaining good EVM performance at the bandwidth (BW) edges and for preventing interference in adjacent frequency bands utilized by other UEs. In some aspects, as shown in FIG. 6, the base station 604 may, at 612, transmit a new condition specifying the “out-of-band requested EVM” via either the MAC-CE or PDCCH. If the UE 602 cannot meet the out-of-band EVM condition due to, for example, hardware limitations, the UE 602 may propose, at 640, as part of the negotiation process 622, to accept a slightly higher (e.g., poorer) in-band error in exchange for improved out-of-band performance (i.e., better stop-band attenuation).

For example, the UE 602 may, as part of the negotiation process for shaping parameters at 640, provide a table containing both in-band and out-of-band error values for various shaping parameters, allowing the base station 604 to determine the most efficient configuration based on its policy priorities, such as throughput, latency, or power consumption. This configuration may include the appropriate MCS, guard band size, and the indicated LPF shaping parameter for the UE 602. In some examples, a lower modulation order may be configured near the bandwidth edges (e.g., near edge frequency region 530) to accommodate poorer EVM in these regions while maintaining the same code rate. In this case, the base station 604, may inform the UE 602 via a DL signal about the lower modulation order and the corresponding allocated bandwidth, enabling the UE 602 to adjust its demodulation settings accordingly.

In some aspects, both the base station 604 and UE 602 may reenter the negotiation process (e.g., negotiation process 622) to adjust the configuration if operational modes or conditions change during the communication process.

In some aspects, one the UE 602 and the base station 604 have identified the set of parameters for the resampling process, including the length of the filter N, the size of the guard band (e.g., G), and the shaping parameters (e.g., the shaping parameter β in case Kaiser window is used), the UE 602 may, at 660 process the input signal using resampling process based on the set of parameters. For example, the UE 602 may process the input signal at 660 to obtain a process signal. In some examples, if the UE 602 cannot meet the requested value of the EVM at 616, and the UE 602 has, at 624, transmitted a threshold value of the EVM, the UE may, at 630, receive, from base station 604, a request to disable the SC-FDMA transmission mechanism. In that case, the UE 602 may, at 660, process the input signal using the transformation process if the UE 602 supports the transformation process. If the UE 602 does not support the transformation process, the UE 602 may, at 660, process the input signal using the resampling process based on an updated EVM.

The UE 602 may further, at 662, communicate the processed signal with the base station 604.

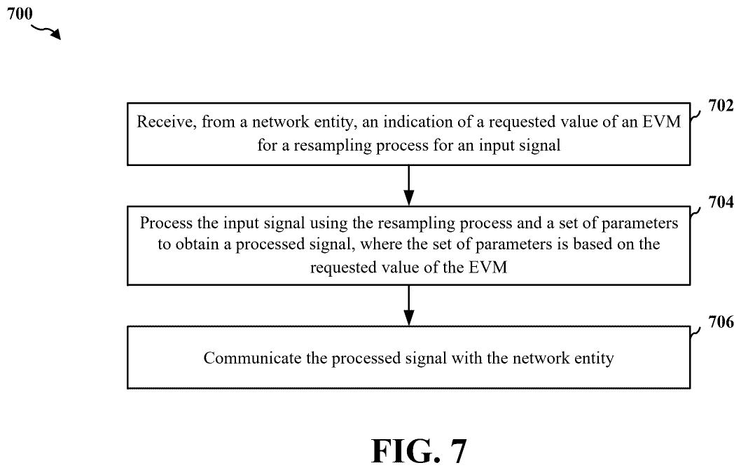

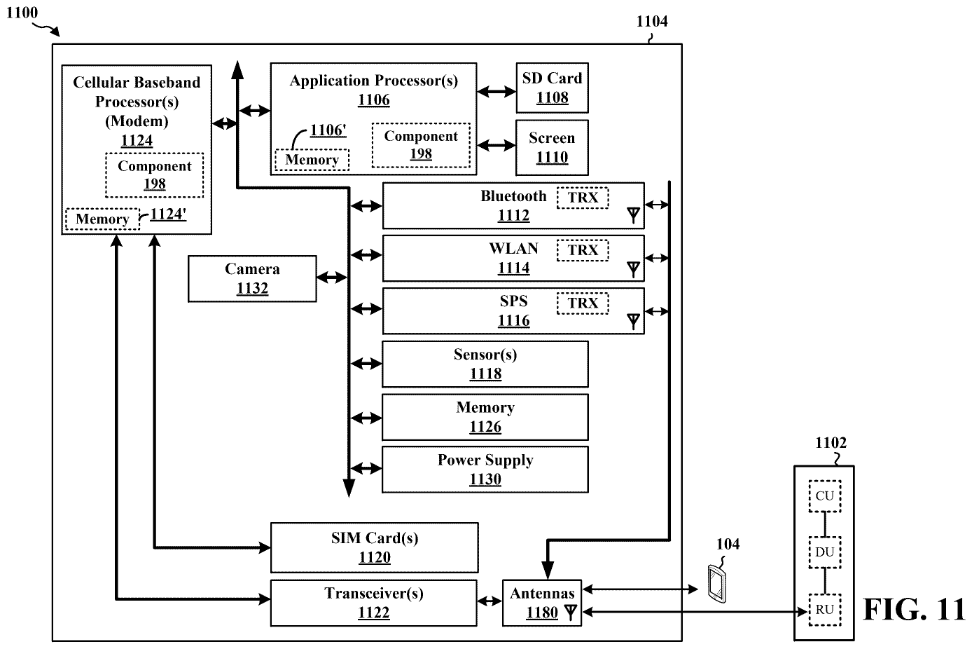

FIG. 7 is a flowchart 700 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 604; or the network entity 1102 in the hardware implementation of FIG. 11). The UE may be the UE 104, 350, 602, or the apparatus 1104 in the hardware implementation of FIG. 11. By replacing DFT and IFFT processes with a resampling method, the methods eliminate numerous multiplication operations involved in the DFT-IFFT processing, thereby reducing the computational load and power consumption in mobile devices, and improving overall efficiency. Additionally, by enabling the negotiation of various parameters involved in the resampling method, including the LPF tap length, guard band size, and shaping parameters, between the UE and the base station, the methods achieve a balance between computational complexity and signal accuracy, considering the UE's capability and the communication quality condition (e.g., the EVM condition).

As shown in FIG. 7, at 702, the UE may receive, from a network entity, an indication of a requested value of an EVM for a resampling process for an input signal. FIG. 4, FIG. 5, and FIG. 6 illustrate various aspects of the steps in connection with flowchart 700. For example, referring to FIG. 6, the UE 602 may, at 614, receive, from a network entity (e.g., base station 604), an indication of a requested value of an EVM for a resampling process (e.g., 410) for an input signal. For example, the referring process may be the resampling process at 410. In some aspects, 702 may be performed by the signal processing component 198.

At 704, the UE may process the input signal using the resampling process and a set of parameters to obtain a processed signal. The set of parameters may be based on the requested value of the EVM. For example, referring to FIG. 6, the UE 602 may, at 660, process the input signal using the resampling process (e.g., 410) and a set of parameters to obtain a processed signal. The set of parameters may be based on the requested value of the EVM (e.g., at 614). In some aspects, 704 may be performed by the signal processing component 198.

At 706, the UE may communicate the processed signal with the network entity. For example, referring to FIG. 6, the UE 602 may, at 662, communicate the processed signal with the network entity (e.g., base station 604). In some aspects, 706 may be performed by the signal processing component 198.

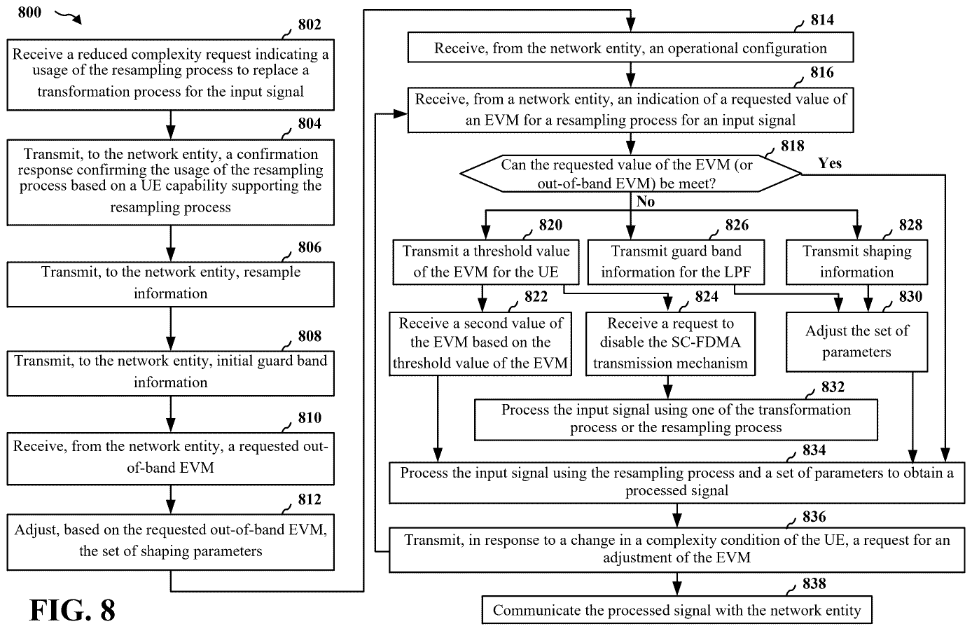

FIG. 8 is a flowchart 800 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 604; or the network entity 1102 in the hardware implementation of FIG. 11). The UE may be the UE 104, 350, 602, or the apparatus 1104 in the hardware implementation of FIG. 11. By replacing DFT and IFFT processes with a resampling method, the methods eliminate numerous multiplication operations involved in the DFT-IFFT processing, thereby reducing the computational load and power consumption in mobile devices, and improving overall efficiency. Additionally, by enabling the negotiation of various parameters involved in the resampling method, including the LPF tap length, guard band size, and shaping parameters, between the UE and the base station, the methods achieve a balance between computational complexity and signal accuracy, considering the UE's capability and the communication quality condition (e.g., the EVM condition).

As shown in FIG. 8, at 816, the UE may receive, from a network entity, an indication of a requested value of an EVM for a resampling process for an input signal. FIG. 4, FIG. 5, and FIG. 6 illustrate various aspects of the steps in connection with flowchart 800. For example, referring to FIG. 6, the UE 602 may, at 614, receive, from a network entity (e.g., base station 604), an indication of a requested value of an EVM for a resampling process (e.g., 410) for an input signal. In some aspects, 816 may be performed by the signal processing component 198.

At 834, the UE may process the input signal using the resampling process and a set of parameters to obtain a processed signal. The set of parameters may be based on the requested value of the EVM. For example, referring to FIG. 6, the UE 602 may, at 660, process the input signal using the resampling process (e.g., 410) and a set of parameters to obtain a processed signal. The set of parameters may be based on the requested value of the EVM (e.g., at 614). In some aspects, 834 may be performed by the signal processing component 198.

At 838, the UE may communicate the processed signal with the network entity. For example, referring to FIG. 6, the UE 602 may, at 662, communicate the processed signal with the network entity (e.g., base station 604). In some aspects, 838 may be performed by the signal processing component 198.

In some aspects, the resampling process may be associated with an SC-FDMA transmission mechanism for communicating with the network entity. At 802, the UE may receive, from the network entity, a reduced complexity request indicating a usage of the resampling process to replace a transformation process for the input signal. At 804, the UE may transmit, to the network entity, a confirmation response confirming the usage of the resampling process based on a UE capability supporting the resampling process. For example, referring to FIG. 4 and FIG. 6, the resampling process (e.g., at 410) may be associated with an SC-FDMA transmission mechanism for communicating with the network entity (e.g., base station 604). At 606, the UE 602 may receive, from the network entity (e.g., base station 604), a reduced complexity request indicating a usage of the resampling process to replace a transformation process for the input signal. For example, at 606, the base station 604 may transmit a downlink signal indicating whether the UE 602 has the reduced-complexity SC-FDMA transmission mechanism (i.e., whether the UE 602 have the capability to use the resampling process (e.g., 410) instead of the DFT-IFFT block (e.g., 420)). At 608, the UE 602 may transmit, to the network entity (e.g., base station 604), a confirmation response (e.g., a response to the downlink signal at 606) confirming the usage of the resampling process based on a UE capability supporting the resampling process (e.g., at 410). In some aspects, 802 and 804 may be performed by the signal processing component 198.

In some aspects, the EVM may be associated with a band error of the resampling process, and the requested value of the EVM may be based on one or more of: an operated modulation and coding scheme (MCS), or a noise condition on an uplink channel. For example, referring to FIG. 5 and FIG. 6, the EVM may be associated with a band error of the resampling process (e.g., the errors at 552), and the requested value of the EVM may be based on one or more of: an operated MCS, or a noise condition on an uplink channel.

In some aspects, the set of parameters may include a first length of an LPF associated with the resampling process, and the first length of the LPF associated with the resampling process may be based on the requested value of the EVM. For example, referring to FIG. 5 and FIG. 6, the set of parameters may include a first length of an LPF (e.g., 550) associated with the resampling process, and the first length of the LPF (e.g., 550) associated with the resampling process may be based on the requested value of the EVM (e.g., at 614).

In some aspects, at 836, the UE may transmit, in response to a change in a complexity condition of the UE, a request for an adjustment of the EVM. The first length of the LPF associated with the resampling process may be based on the change in the complexity condition. For example, referring to FIG. 6, when there is a change in a complexity condition of the UE 602 (e.g., when the UE 602 tightens or relaxes the low-complexity condition at 642), the UE 602 may request for an adjustment of the EVM (e.g., the UE 602 may reenter the negotiation process 622 at 644). The first length of the LPF associated with the resampling process may be based on the change in the complexity condition (e.g., at 642). In some aspects, 836 may be performed by the signal processing component 198.

In some aspects, the first length of the LPF associated with the resampling process may be based on a first number of taps for the LPF associated with the resampling process. The first number of taps are identified, in response to a capability to meet the requested value of the EVM and based on a mapping relationship between the EVM and numbers of the taps for the LPF. For example, referring to FIG. 5 and FIG. 6, the first length of the LPF (e.g., 550) associated with the resampling process may be based on a first number of taps for the LPF associated with the resampling process. For example, the first number of taps are identified, at 618, based on the UE's capability to meet the requested value of the EVM (e.g., at 616). Referring to Table 3, the first number of taps may be identified based on the mapping relationship between the EVM and numbers of the taps for the LPF, as shown in Table 3.

In some aspects, at 806, the UE may transmit, to the network entity, resample information. The resample information may include one or more of: a confirmation for the usage of the resampling process, an expected value of the EVM for the resampling process, or latency information associated with the numbers of the taps for the LPF. For example, referring to FIG. 6, the UE 602 may, at 620, transmit, to the network entity (e.g., base station 604), resample information. The resample information may include one or more of: a confirmation for the usage of the resampling process, an expected value of the EVM for the resampling process (e.g., 650), or latency information associated with the numbers of the taps for the LPF (e.g., latency table 652). In some aspects, 806 may be performed by the signal processing component 198.

In some aspects, the UE may determine, at 818, whether it can meet the requested value of the EVM. If the UE cannot meet the requested value of the EVM, the UE may, at 820, transmit a threshold value of the EVM for the UE. The threshold value may be lower than the requested value. For example, referring to FIG. 6, the UE 602 may, at 616, determine whether it can meet the requested value of the EVM. If the UE cannot meet the requested value of the EVM, the UE may enter the negotiation process 622. For example, as part of the negotiation process 622, the UE 602 may, at 624, transmit a threshold value of the EVM (e.g., the best or lowest EVM) for the UE 602. The threshold value may be lower than the requested value (e.g., at 614). In some aspects, 818 and 820 may be performed by the signal processing component 198.

In some aspects, if the UE cannot meet the requested value of the EVM and has transmitted a threshold value of the EVM (e.g., at 820), the UE may, at 822, receive, from the network entity, a second value of the EVM based on the threshold value of the EVM. The first length of the LPF is based on the second value of the EVM. For example, referring to FIG. 6, the UE 602 may, at 628, receive, from the network entity (e.g., base station 604), a second value of the EVM (e.g., an updated value of the EVM) based on the threshold value of the EVM. The first length of the LPF is based on the second value of the EVM. In some aspects, 822 may be performed by the signal processing component 198.

In some aspects, the second value of the EVM is based on a second MCS lower than the operated MCS. For example, referring to FIG. 6, the base station may indicate a lowered MCS at 626, the second value of the EVM may be based on a second MCS (e.g., the lowered MCS at 626), which may be lower than the operated MCS.

In some aspects, if the UE cannot meet the requested value of the EVM and has transmitted a threshold value of the EVM (e.g., at 820), the UE may, at 824, receive, from the network entity, a request to disable the SC-FDMA transmission mechanism, and the UE may, at 832, process the input signal using the transformation process or the resampling process, depending on whether the UE supports of the transformation process. For example, referring to FIG. 6, if the UE 602 cannot meet the requested value of the EVM at 616, and the UE 602 has, at 624, transmitted a threshold value of the EVM, the UE may, at 630, receive, from the network entity (e.g., base station 604), a request to disable the SC-FDMA transmission mechanism. The UE 602 may, at 660, process the input signal using the transformation process or the resampling process, depending on whether the UE supports of the transformation process. In some aspects, 824 and 832 may be performed by the signal processing component 198.

In some aspects, at 832, if the UE supports the transformation process, the UE may process the input signal using the transformation process. For example, referring to FIG. 6, if the UE 602 supports the transformation process, the UE 602 may, at 660, process the input signal using the transformation process.

In some aspects, at 832, if the UE does not support the transformation process, the UE may transmit to the network entity a capability indication indicative the lack of the support of the transformation process; and process the input signal using the resampling process based on a third value of the EVM lower than the requested value of the EVM. For example, referring to FIG. 6, if the UE 602 does not support the transformation process, the UE 602 may, at 632, transmit to the network entity (e.g., base station 604) a capability indication indicative the lack of the support of the transformation process. Then, the UE 602 may process the input signal (e.g., at 660) using the resampling process based on a third value of the EVM lower than the requested value of the EVM.

In some aspects, the set of parameters may further include a second length of a guard band associated with the resampling process. The guard band may be located between a cutoff frequency and an edge of a frequency domain allocation associated with the resampling process. For example, referring to FIG. 5 and FIG. 6, the set of parameters may further include a second length of a guard band (e.g., guard band 506, 508) associated with the resampling process. The guard band (e.g., guard band 506, 508) may be located between a cutoff frequency and an edge of a frequency domain allocation associated with the resampling process (e.g., between f₁ 516 and fₐ₁ 526, or between f₂ 518 and fₐ₂ 528).

In some aspects, if the UE cannot meet the requested value of the EVM, the UE may, at 826, transmit to the network entity guard band information for the LPF associated with the resampling process, and, at 830, adjust the second length of the guard band associated with the resampling process based on the guard band information. For example, referring to FIG. 6, the UE may, at 636, transmit to the network entity (e.g., base station 604) guard band information for the LPF associated with the resampling process. In some aspects, 826 and 830 may be performed by the signal processing component 198.

In some aspects, the guard band information may include: the minimal addition of the guard band, or the changed value of the EVM for the minimal addition of the guard band. For example, referring to FIG. 6, the guard band information may include: the minimal addition of the guard band (e.g., 646), or the changed value of the EVM (e.g., 648) for the minimal addition of the guard band.

In some aspects, at 808, the UE may transmit, to the network entity, initial guard band information. The initial guard band information may include one or more values of the EVM respectively corresponding to one or more combinations of the second length of the guard band and the first value of the LPF. For example, referring to FIG. 6, the UE 602 may, at 610, transmit, to the network entity (e.g., base station 604), initial guard band information. The initial guard band information may include one or more values of the EVM respectively corresponding to one or more combinations of the second length of the guard band and the first value of the LPF. In some aspects, 808 may be performed by the signal processing component 198.

In some aspects, the set of parameters may further include a set of shaping parameters for the resampling process. The set of shaping parameters may be associated with an in-band EVM and an out-of-band EVM in the resampling process. For example, referring to FIG. 6, the set of parameters may further include a set of shaping parameters for the resampling process. The set of shaping parameters may be associated with an in-band EVM (e.g., associated with in-band error 552) and an out-of-band EVM (e.g., associated with out-of-band error 542) in the resampling process.

In some aspects, at 810, the UE may receive, from the network entity, a requested out-of-band EVM, and, at 812, adjust, based on the requested out-of-band EVM, the set of shaping parameters. For example, referring to FIG. 6, the UE 602 may, at 612, receive, from the network entity (e.g., base station 604), a requested out-of-band EVM, and, adjust (during the negotiation process 622) based on the requested out-of-band EVM, the set of shaping parameters. In some aspects, 810 and 812 may be performed by the signal processing component 198.

In some aspects, if the UE cannot meet the requested out-of-band EVM, the UE may, at 828, transmit shaping information including a suggested in-band EVM lower than a current in-band EVM and, at 830, adjust, based on the shaping information, the set of shaping parameters. For example, referring to FIG. 6, the UE 602 may, at 640, as part of the negotiation process for the shaping parameters, transmit shaping information including a suggested in-band EVM lower than a current in-band EVM and adjust, based on the shaping information, the set of shaping parameters. In some aspects, 828 may be performed by the signal processing component 198.

In some aspects, the shaping information (e.g., at 828) may further include multiple in-band errors and out-of-band errors respectively corresponding to multiple values of the set of shaping parameters. For example, referring to FIG. 6, the shaping information (e.g., at 640) may further include multiple in-band errors and out-of-band errors respectively corresponding to multiple values of the set of shaping parameters.

In some aspects, at 814, the UE may receive, from the network entity, an operational configuration. The operational configuration may include one or more of: the operated MCS, the selected length of a guard band associated with the resampling process, or the selected set of shaping parameters. To process the input signal using the resampling process (e.g., at 834), the UE may process the input signal using the resampling process based on the operational configuration. For example, referring to FIG. 6, the UE 602 may, at 614, receive, from the network entity (e.g., base station 604), an operational configuration. The operational configuration may include one or more of: the operated MCS, the selected length of a guard band associated with the resampling process, or the selected set of shaping parameters. The UE 602 may, at 666, process the input signal using the resampling process based on the operational configuration.

In some aspects, to process the input signal using the resampling process to obtain the processed signal (e.g., at 834), the UE may process the input signal using a first modulation order on a first region of a bandwidth of the LPF associated with the resampling process and a second modulation order on a second region of the bandwidth. The second region may be located closer to an edge of the bandwidth than the first region, and the second modulation order is lower than the first modulation order. For example, referring to FIG. 5 and FIG. 6, the UE 602 may process the input signal using a first modulation order on a first region of a bandwidth of the LPF associated with the resampling process and a second modulation order on a second region of the bandwidth. The second region (e.g., edge frequency region 530) may be located closer to an edge of the bandwidth than the first region (e.g., center frequency region 520), and the second modulation order is lower than the first modulation order.

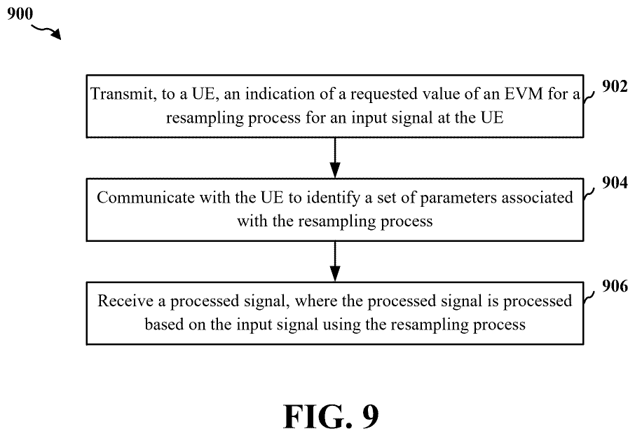

FIG. 9 is a flowchart 900 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 604; or the network entity 1102 in the hardware implementation of FIG. 11). The UE may be the UE 104, 350, 602, or the apparatus 1104 in the hardware implementation of FIG. 11. By replacing DFT and IFFT processes with a resampling method, the methods eliminate numerous multiplication operations involved in the DFT-IFFT processing, thereby reducing the computational load and power consumption in mobile devices, and improving overall efficiency. Additionally, by enabling the negotiation of various parameters involved in the resampling method, including the LPF tap length, guard band size, and shaping parameters, between the UE and the base station, the methods achieve a balance between computational complexity and signal accuracy, considering the UE's capability and the communication quality condition (e.g., the EVM condition).

As shown in FIG. 9, at 902, the network entity may transmit, to a UE, an indication of a requested value of an EVM for a resampling process for an input signal at the UE. FIG. 4, FIG. 5, and FIG. 6 illustrate various aspects of the steps in connection with flowchart 900. For example, referring to FIG. 6, the network entity (e.g., base station 604) may, at 614, transmit, to a UE 602, an indication of a requested value of an EVM for a resampling process for an input signal at the UE 602. In some aspects, 902 may be performed by the signal processing component 199.

At 904, the network entity may communicate with the UE to identify a set of parameters associated with the resampling process. For example, referring to FIG. 6, the network entity (e.g., base station 604) may, during the negotiation process 622, communicate with the UE 602 to identify a set of parameters associated with the resampling process. In some aspects, 904 may be performed by the signal processing component 199.

At 906, the network entity may receive a processed signal. The processed signal is processed based on the input signal using the resampling process. For example, referring to FIG. 6, the network entity (e.g., base station 604) may, at 662, receive a processed signal. The processed signal is processed based on the input signal using the resampling process. In some aspects, 906 may be performed by the signal processing component 199.

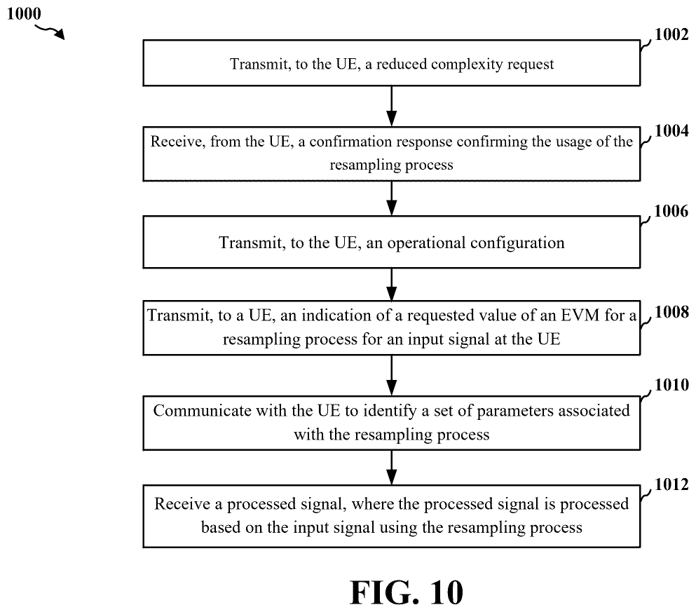

FIG. 10 is a flowchart 1000 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 604; or the network entity 1102 in the hardware implementation of FIG. 11). The UE may be the UE 104, 350, 602, or the apparatus 1104 in the hardware implementation of FIG. 11. By replacing DFT and IFFT processes with a resampling method, the methods eliminate numerous multiplication operations involved in the DFT-IFFT processing, thereby reducing the computational load and power consumption in mobile devices, and improving overall efficiency. Additionally, by enabling the negotiation of various parameters involved in the resampling method, including the LPF tap length, guard band size, and shaping parameters, between the UE and the base station, the methods achieve a balance between computational complexity and signal accuracy, considering the UE's capability and the communication quality condition (e.g., the EVM condition).

As shown in FIG. 10, at 1008, the network entity may transmit, to a UE, an indication of a requested value of an EVM for a resampling process for an input signal at the UE. FIG. 4, FIG. 5, and FIG. 6 illustrate various aspects of the steps in connection with flowchart 1000. For example, referring to FIG. 6, the network entity (e.g., base station 604) may, at 614, transmit, to a UE 602, an indication of a requested value of an EVM for a resampling process for an input signal at the UE. In some aspects, 1008 may be performed by the signal processing component 199.

At 1010, the network entity may communicate with the UE to identify a set of parameters associated with the resampling process. For example, referring to FIG. 6, the network entity (e.g., base station 604) may, during the negotiation process 622, communicate with the UE 602 to identify a set of parameters associated with the resampling process. In some aspects, 1010 may be performed by the signal processing component 199.

At 1012, the network entity may receive a processed signal. The processed signal is processed based on the input signal using the resampling process. For example, referring to FIG. 6, the network entity (e.g., base station 604) may, at 662, receive a processed signal. The processed signal is processed based on the input signal using the resampling process. In some aspects, 1012 may be performed by the signal processing component 199.

In some aspects, the resampling process may be associated with an SC-FDMA transmission mechanism for communicating with the network entity. The may network entity may, at 1002, transmit, to the UE, a reduced complexity request indicating a usage of the resampling process to replace a transformation process for the input signal, and, at 1004, receive, from the UE, a confirmation response confirming the usage of the resampling process based on a UE capability supporting the resampling process. For example, referring to FIG. 6, the resampling process may be associated with an SC-FDMA transmission mechanism for communicating with the network entity. The may network entity (e.g., base station 604) may, at 606, transmit, to the UE 602, a reduced complexity request indicating a usage of the resampling process to replace a transformation process for the input signal, and, at 608, receive, from the UE 602, a confirmation response confirming the usage of the resampling process based on a UE capability supporting the resampling process. In some aspects, 1002 and 1004 may be performed by the signal processing component 199.

In some aspects, the EVM may be associated with a band error of the resampling process, and the requested value of the EVM is based on one or more of: an operated MCS, or a noise condition on an uplink channel. For example, referring to FIG. 6, the EVM (e.g., at 612) may be associated with a band error of the resampling process, and the requested value of the EVM (e.g., at 612) is based on one or more of: an operated MCS, or a noise condition on an uplink channel.

In some aspects, the set of parameters may include: a first length of a low-pass filter (LPF) associated with the resampling process, a second length of a guard band associated with the resampling process, wherein the guard band is located between a cutoff frequency and an edge of a frequency domain allocation associated with the resampling process, and a set of shaping parameters for the resampling process. The set of shaping parameters is associated with an in-band EVM and an out-of-band EVM in the resampling process. For example, referring to FIG. 5 and FIG. 6, the set of parameters may include the first length (e.g., 550) of an LPF associated with the resampling process, a second length of a guard band (e.g., guard band 506, 508) associated with the resampling process. The guard band (e.g., guard band 506, 508) may be located between a cutoff frequency and an edge of a frequency domain allocation associated with the resampling process (e.g., between f₁ 516 and fₐ₁ 526, or between f₂ 518 and fₐ₂ 528). The set of parameters may further include a set of shaping parameters for the resampling process. The set of shaping parameters may be associated with an in-band EVM (e.g., associated with in-band error 552) and an out-of-band EVM (e.g., associated with out-of-band error 542) in the resampling process.

In some aspects, the network entity may, at 1006, transmit to the UE an operational configuration. The operational configuration may include one or more of: the operated MCS, the selected length of the guard band, or the selected set of shaping parameters. The input signal may be processed (e.g., at 1012) using the resampling process based on the operational configuration. For example, referring to FIG. 6, the network entity (e.g., base station 604) may, at 614, transmit to the UE 602 an operational configuration. The operational configuration may include one or more of: the operated MCS, the selected length of the guard band, or the selected set of shaping parameters. The input signal may be processed (e.g., at 660) using the resampling process based on the operational configuration. In some aspects, 1006 may be performed by the signal processing component 199.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor (or processing circuitry) 1124 (also referred to as a modem) coupled to one or more transceivers 1122 (e.g., cellular RF transceiver). The cellular baseband processor(s) (or processing circuitry) 1124 may include at least one on-chip memory (or memory circuitry) 1124′. In some aspects, the apparatus 1104 may further include one or more subscriber identity modules (SIM) cards 1120 and at least one application processor (or processing circuitry) 1106 coupled to a secure digital (SD) card 1108 and a screen 1110. The application processor(s) (or processing circuitry) 1106 may include on-chip memory (or memory circuitry) 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) (or processing circuitry) 1124 communicates through the transceiver(s) 1122 via one or more antennas 1180 with the UE 104 and/or with an RU associated with a network entity 1102. The cellular baseband processor(s) (or processing circuitry) 1124 and the application processor(s) (or processing circuitry) 1106 may each include a computer-readable medium/memory (or memory circuitry) 1124′, 1106′, respectively. The additional memory modules 1126 may also be considered a computer-readable medium/memory (or memory circuitry). Each computer-readable medium/memory (or memory circuitry) 1124′, 1106′, 1126 may be non-transitory. The cellular baseband processor(s) (or processing circuitry) 1124 and the application processor(s) (or processing circuitry) 1106 are each responsible for general processing, including the execution of software stored on the computer-readable medium/memory (or memory circuitry). The software, when executed by the cellular baseband processor(s) (or processing circuitry) 1124/application processor(s) (or processing circuitry) 1106, causes the cellular baseband processor(s) (or processing circuitry) 1124/application processor(s) (or processing circuitry) 1106 to perform the various functions described supra. The cellular baseband processor(s) (or processing circuitry) 1124 and the application processor(s) (or processing circuitry) 1106 are configured to perform the various functions described supra based at least in part of the information stored in the memory (or memory circuitry). That is, the cellular baseband processor(s) (or processing circuitry) 1124 and the application processor(s) (or processing circuitry) 1106 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1124/application processor(s) (or processing circuitry) 1106 when executing software. The cellular baseband processor(s) (or processing circuitry) 1124/application processor(s) (or processing circuitry) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) (or processing circuitry) 1124 and/or the application processor(s) (or processing circuitry) 1106, and in another configuration, the apparatus 1104 may be the entire UE (e.g., see UE 350 of FIG. 3) and include the additional modules of the apparatus 1104.

As discussed supra, the component 198 may be configured to receive, from a network entity, an indication of a requested value of an EVM for a resampling process for an input signal; process the input signal using the resampling process and a set of parameters to obtain a processed signal, where the set of parameters is based on the requested value of the EVM; and communicate the processed signal with the network entity. The component 198 may be further configured to perform any of the aspects described in connection with the flowcharts in FIG. 7 and FIG. 8, and/or performed by the UE 602 in FIG. 6. The component 198 may be within the cellular baseband processor(s) (or processing circuitry) 1124, the application processor(s) (or processing circuitry) 1106, or both the cellular baseband processor(s) (or processing circuitry) 1124 and the application processor(s) (or processing circuitry) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) (or processing circuitry) 1124 and/or the application processor(s) (or processing circuitry) 1106, includes means for receiving, from a network entity, an indication of a requested value of an EVM for a resampling process for an input signal; means for processing the input signal using the resampling process and a set of parameters to obtain a processed signal, where the set of parameters is based on the requested value of the EVM; and means for communicating the processed signal with the network entity. The apparatus 1104 may further include means for performing any of the aspects described in connection with the flowcharts in FIG. 7 and FIG. 8, and/or aspects performed by the UE 602 in FIG. 6. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

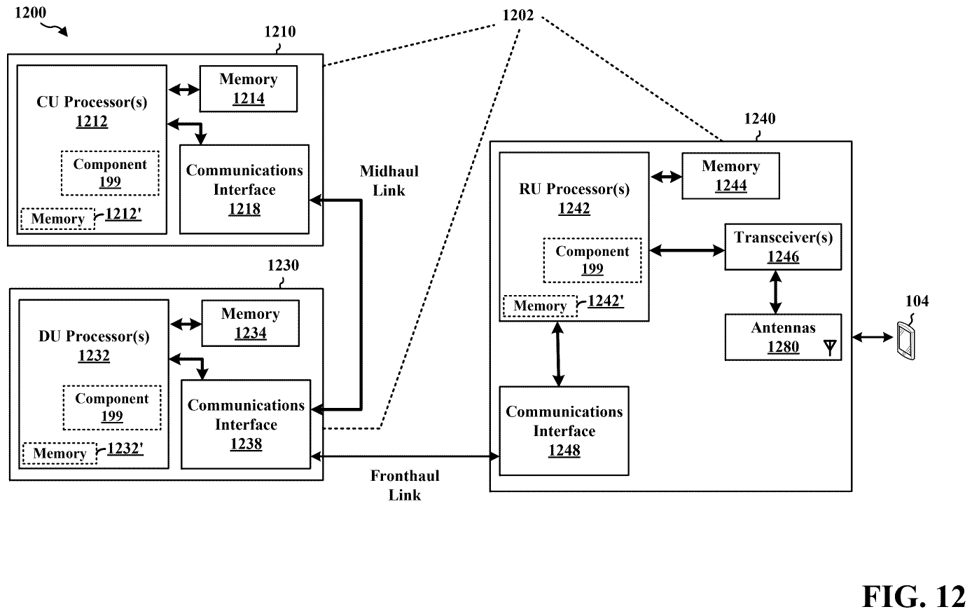

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor (or processing circuitry) 1212. The CU processor(s) (or processing circuitry) 1212 may include on-chip memory (or memory circuitry) 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor (or processing circuitry) 1232. The DU processor(s) (or processing circuitry) 1232 may include on-chip memory (or memory circuitry) 1232′. In some aspects, the DU 1230 may further include additional memory modules 1234 and a communications interface 1238. The DU 1230 communicates with the RU 1240 through a fronthaul link. The RU 1240 may include at least one RU processor (or processing circuitry) 1242. The RU processor(s) (or processing circuitry) 1242 may include on-chip memory (or memory circuitry) 1242′. In some aspects, the RU 1240 may further include additional memory modules 1244, one or more transceivers 1246, antennas 1280, and a communications interface 1248. The RU 1240 communicates with the UE 104. The on-chip memory (or memory circuitry) 1212′, 1232′, 1242′ and the additional memory modules 1214, 1234, 1244 may each be considered a computer-readable medium/memory (or memory circuitry). Each computer-readable medium/memory (or memory circuitry) may be non-transitory. Each of the processors (or processing circuitry) 1212, 1232, 1242 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, to a UE, an indication of a requested value of an EVM for a resampling process for an input signal at the UE; communicate with the UE to identify a set of parameters associated with the resampling process; and receive a processed signal, where the processed signal is processed based on the input signal using the resampling process. The component 199 may be further configured to perform any of the aspects described in connection with the flowcharts in FIG. 9 and FIG. 10, and/or performed by the base station 604 in FIG. 6. The component 199 may be within one or more processors (or processing circuitry) of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 includes means for transmitting, to a UE, an indication of a requested value of an EVM for a resampling process for an input signal at the UE; means for communicating with the UE to identify a set of parameters associated with the resampling process; and means for receiving a processed signal, where the processed signal is processed based on the input signal using the resampling process. The network entity 1202 may further include means for performing any of the aspects described in connection with the flowcharts in FIG. 9 and FIG. 10, and/or aspects performed by the base station 604 in FIG. 6. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, an indication of a requested value of an EVM for a resampling process for an input signal; processing the input signal using the resampling process and a set of parameters to obtain a processed signal, where the set of parameters is based on the requested value of the EVM; and communicating the processed signal with the network entity. By replacing DFT and IFFT processes with a resampling method, the methods eliminate numerous multiplication operations involved in the DFT-IFFT processing, thereby reducing the computational load and power consumption in mobile devices, and improving overall efficiency. Additionally, by enabling the negotiation of various parameters involved in the resampling method, including the LPF tap length, guard band size, and shaping parameters, between the UE and the base station, the methods achieve a balance between computational complexity and signal accuracy, considering the UE's capability and the communication quality condition (e.g., the EVM condition).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes receiving, from a network entity, an indication of a requested value of an error vector magnitude (EVM) for a resampling process for an input signal; processing the input signal using the resampling process and a set of parameters to obtain a processed signal, wherein the set of parameters is based on the requested value of the EVM; and communicating the processed signal with the network entity.

Aspect 2 is the method of aspect 1, wherein the resampling process is associated with a single-carrier frequency division multiple access (SC-FDMA) transmission mechanism for communicating with the network entity, and where the method further includes receiving, from the network entity, a reduced complexity request indicating a usage of the resampling process to replace a transformation process for the input signal; and transmitting, to the network entity, a confirmation response confirming the usage of the resampling process based on a UE capability supporting the resampling process.

Aspect 3 is the method of any of aspects 1 to 2, wherein the EVM is associated with a band error of the resampling process, and the requested value of the EVM is based on one or more of: an operated modulation and coding scheme (MCS), or a noise condition on an uplink channel.

Aspect 4 is the method of aspect 3, wherein the set of parameters includes a first length of a low-pass filter (LPF) associated with the resampling process, and wherein the first length of the LPF associated with the resampling process is based on the requested value of the EVM.

Aspect 5 is the method of any of aspects 1 to 4, where the method further includes transmitting, in response to a change in a complexity condition of the UE, a request for an adjustment of the EVM, and wherein the first length of the LPF associated with the resampling process is based on the change in the complexity condition.

Aspect 6 is the method of any of aspects 1 to 4, wherein the first length of the LPF associated with the resampling process is based on a first number of taps for the LPF associated with the resampling process, and wherein the first number of taps are identified, in response to a capability to meet the requested value of the EVM and based on a mapping relationship between the EVM and numbers of the taps for the LPF.

Aspect 7 is the method of aspect 6, where the method further includes transmitting, to the network entity, resample information comprising one or more of: a confirmation for the usage of the resampling process, an expected value of the EVM for the resampling process, or latency information associated with the numbers of the taps for the LPF.

Aspect 8 is the method of any of aspects 1 to 4, where the method further includes transmitting, in response to a lack of a capability to meet the requested value of the EVM, a threshold value of the EVM for the UE, wherein the threshold value is lower than the requested value.

Aspect 9 is the method of aspect 8, where the method further includes receiving, from the network entity, a second value of the EVM based on the threshold value of the EVM, and wherein the first length of the LPF is based on the second value of the EVM.

Aspect 10 is the method of aspect 9, wherein the second value of the EVM is based on a second MCS lower than the operated MCS.

Aspect 11 is the method of aspect 9, where the method further includes receiving, from the network entity, a request to disable the SC-FDMA transmission mechanism; and processing, based on a support of the transformation process, the input signal using one of the transformation process or the resampling process.

Aspect 12 is the method of aspect 11, where processing the input signal using one of the transformation process or the resampling process includes processing, based on the support of the transformation process, the input signal using the transformation process.

Aspect 13 is the method of aspect 11, where wherein processing the input signal using one of the transformation process or the resampling process includes transmitting, in response to a non-support (e.g., a lack of support) of the transformation process, a capability indication indicative the non-support of the transformation process; and processing the input signal using the resampling process based on a third value of the EVM lower than the requested value of the EVM.

Aspect 14 is the method of any of aspects 1 to 4, wherein the set of parameters further includes a second length of a guard band associated with the resampling process, and wherein the guard band is located between a cutoff frequency and an edge of a frequency domain allocation associated with the resampling process.

Aspect 15 is the method of aspect 14, where the method further includes transmitting, to the network entity, in response to a lack of a capability to meet the requested value of the EVM, guard band information for the LPF associated with the resampling process; and adjusting, based on the guard band information, the second length of the guard band associated with the resampling process.

Aspect 16 is the method of aspect 15, wherein the guard band information includes: a minimal addition of the guard band, or a changed value of the EVM for the minimal addition of the guard band.

Aspect 17 is the method of aspect 14, where the method further includes transmitting, to the network entity, initial guard band information, wherein the initial guard band information includes one or more values of the EVM respectively corresponding to one or more combinations of the second length of the guard band and the first value of the LPF.

Aspect 18 is the method of any of aspects 1 to 4, wherein the set of parameters further includes a set of shaping parameters for the resampling process, and wherein the set of shaping parameters is associated with an in-band EVM and an out-of-band EVM in the resampling process.

Aspect 19 is the method of any of aspects 1 to 4, where the method further includes receiving, from the network entity, a requested out-of-band EVM; and adjusting, based on the requested out-of-band EVM, the set of shaping parameters.

Aspect 20 is the method of aspect 19, where the method further includes transmitting, in response to a lack of a capability to meet the requested out-of-band EVM, shaping information comprising a suggested in-band EVM lower than a current in-band EVM; and adjusting, based on the shaping information, the set of shaping parameters.

Aspect 21 is the method of aspect 20, wherein the shaping information further comprises multiple in-band errors and out-of-band errors respectively corresponding to multiple values of the set of shaping parameters.

Aspect 22 is the method of aspect 18, where the method further includes receiving, from the network entity, an operational configuration including one or more of: the operated MCS, a selected length of a guard band associated with the resampling process, or a selected set of shaping parameters. Processing the input signal using the resampling process includes processing, based on the operational configuration, the input signal using the resampling process.

Aspect 23 is the method of aspect 18, processing the input signal using the resampling process to obtain the processed signal includes processing the input signal using a first modulation order on a first region of a bandwidth of the LPF associated with the resampling process and a second modulation order on a second region of the bandwidth, wherein the second region is located closer to an edge of the bandwidth than the first region, and the second modulation order is lower than the first modulation order.

Aspect 24 is an apparatus for wireless communication at a UE, comprising: at least one memory; and at least one processor coupled to the at least one memory, the at least one processor is configured to perform the method of any of aspects 1 to 23.

Aspect 25 is the apparatus for wireless communication at a UE, comprising means for performing each step in the method of any of aspects 1-23.

Aspect 26 is an apparatus of any of aspects 24-25, further comprising a transceiver configured to receive or to transmit in association with the method of any of aspects 1-23.

Aspect 27 is a computer-readable medium (e.g., a non-transitory computer-readable medium) storing computer executable code at a UE, the code when executed by at least one processor causes the at least one processor to perform the method of any of aspects 1-23.

Aspect 28 is a method of wireless communication at a network entity. The method includes transmitting, to a user equipment (UE), an indication of a requested value of an error vector magnitude (EVM) for a resampling process for an input signal at the UE; communicating with the UE to identify a set of parameters associated with the resampling process; and receiving a processed signal, wherein the processed signal is processed based on the input signal using the resampling process.

Aspect 29 is the method of aspect 28, wherein the resampling process is associated with a single-carrier frequency division multiple access (SC-FDMA) transmission mechanism for communicating with the network entity, and where the method further includes transmitting, to the UE, a reduced complexity request indicating a usage of the resampling process to replace a transformation process for the input signal; and receiving, from the UE, a confirmation response confirming the usage of the resampling process based on a UE capability supporting the resampling process.

Aspect 30 is the method of any of aspects 28 to 29, wherein the EVM is associated with a band error of the resampling process, and the requested value of the EVM is based on one or more of: an operated modulation and coding scheme (MCS), or a noise condition on an uplink channel.

Aspect 31 is the method of aspect 30, wherein the set of parameters includes: a first length of a low-pass filter (LPF) associated with the resampling process, a second length of a guard band associated with the resampling process, wherein the guard band is located between a cutoff frequency and an edge of a frequency domain allocation associated with the resampling process, and a set of shaping parameters for the resampling process, wherein the set of shaping parameters is associated with an in-band EVM and an out-of-band EVM in the resampling process.

Aspect 32 is the method of aspect 31, where the method further includes transmitting, to the UE, an operational configuration including one or more of: the operated MCS, a selected length of the guard band, or a selected set of shaping parameters, wherein the input signal is processed using the resampling process based on the operational configuration.

Aspect 33 is an apparatus for wireless communication at a network entity, comprising: at least one memory; and at least one processor coupled to the at least one memory and, where the at least one processor is configured to perform the method of any of aspects 28-32.

Aspect 34 is the apparatus for wireless communication at a network entity, comprising means for performing each step in the method of any of aspects 28-32.

Aspect 35 is an apparatus of any of aspects 33-34, further comprising a transceiver configured to receive or to transmit in association with the method of any of aspects 28-32.

Aspect 36 is a computer-readable medium (e.g., a non-transitory computer-readable medium) storing computer executable code at a network entity, the code when executed by at least one processor causes the at least one processor to perform the method of any of aspects 28-32.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, from a network entity, an indication of a requested value of an error vector magnitude (EVM) for a resampling process for an input signal;
process the input signal using the resampling process and a set of parameters to obtain a processed signal, wherein the set of parameters is based on the requested value of the EVM; and
communicate the processed signal with the network entity.

2. The apparatus of claim 1, further comprising a transceiver coupled to the at least one processor, wherein to receive the indication of the requested value of the EVM, the at least one processor is configured to receive the indication of the requested value of the EVM via the transceiver, wherein the resampling process is associated with a single-carrier frequency division multiple access (SC-FDMA) transmission mechanism for communicating with the network entity, and wherein the at least one processor is further configured to:
receive, from the network entity, a reduced complexity request indicating a usage of the resampling process to replace a transformation process for the input signal; and
transmit, to the network entity, a confirmation response confirming the usage of the resampling process based on a UE capability supporting the resampling process.

3. The apparatus of claim 2, wherein the EVM is associated with a band error of the resampling process, and the requested value of the EVM is based on one or more of:
an operated modulation and coding scheme (MCS), or
a noise condition on an uplink channel.

4. The apparatus of claim 3, wherein the set of parameters includes a first length of a low-pass filter (LPF) associated with the resampling process, and wherein the first length of the LPF associated with the resampling process is based on the requested value of the EVM.

5. The apparatus of claim 4, wherein the at least one processor is further configured to:
transmit, in response to a change in a complexity condition of the UE, a request for an adjustment of the EVM, and wherein the first length of the LPF associated with the resampling process is based on the change in the complexity condition.

6. The apparatus of claim 4, wherein the first length of the LPF associated with the resampling process is based on a first number of taps for the LPF associated with the resampling process, and wherein the first number of taps are identified, in response to a capability to meet the requested value of the EVM and based on a mapping relationship between the EVM and numbers of the taps for the LPF.

7. The apparatus of claim 6, wherein the at least one processor is further configured to:
transmit, to the network entity, resample information comprising one or more of:
a confirmation for the usage of the resampling process,
an expected value of the EVM for the resampling process, or
latency information associated with the numbers of the taps for the LPF.

8. The apparatus of claim 4, wherein the at least one processor is further configured to:
transmit, in response to a lack of a capability to meet the requested value of the EVM, a threshold value of the EVM for the UE, wherein the threshold value is lower than the requested value.

9. The apparatus of claim 8, wherein the at least one processor is further configured to:
receive, from the network entity, a second value of the EVM based on the threshold value of the EVM, and wherein the first length of the LPF is based on the second value of the EVM.

10. The apparatus of claim 9, wherein the second value of the EVM is based on a second MCS lower than the operated MCS.

11. The apparatus of claim 9, wherein the at least one processor is further configured to:
receive, from the network entity, a request to disable the SC-FDMA transmission mechanism; and
process, based on a support of the transformation process, the input signal using one of the transformation process or the resampling process.

12. The apparatus of claim 11, wherein to process the input signal using one of the transformation process or the resampling process, the at least one processor is configured to:
process, based on the support of the transformation process, the input signal using the transformation process.

13. The apparatus of claim 11, wherein to process the input signal using one of the transformation process or the resampling process, the at least one processor is configured to:
transmit, in response to a non-support of the transformation process, a capability indication indicative the non-support of the transformation process; and
process the input signal using the resampling process based on a third value of the EVM lower than the requested value of the EVM.

14. The apparatus of claim 4, wherein the set of parameters further includes a second length of a guard band associated with the resampling process, and wherein the guard band is located between a cutoff frequency and an edge of a frequency domain allocation associated with the resampling process.

15. The apparatus of claim 14, wherein the at least one processor is further configured to:
transmit, to the network entity, in response to a lack of a capability to meet the requested value of the EVM, guard band information for the LPF associated with the resampling process; and
adjust, based on the guard band information, the second length of the guard band associated with the resampling process.

16. The apparatus of claim 15, wherein the guard band information includes:
a minimal addition of the guard band, or
a changed value of the EVM for the minimal addition of the guard band.

17. The apparatus of claim 14, wherein the at least one processor is further configured to:
transmit, to the network entity, initial guard band information, wherein the initial guard band information includes one or more values of the EVM respectively corresponding to one or more combinations of the second length of the guard band and a first value of the LPF.

18. The apparatus of claim 4, wherein the set of parameters further includes a set of shaping parameters for the resampling process, and wherein the set of shaping parameters is associated with an in-band EVM and an out-of-band EVM in the resampling process.

19. The apparatus of claim 18, wherein the at least one processor is further configured to:
receive, from the network entity, a requested out-of-band EVM; and
adjust, based on the requested out-of-band EVM, the set of shaping parameters.

20. The apparatus of claim 19, wherein the at least one processor is further configured to:
transmit, in response to a lack of a capability to meet the requested out-of-band EVM, shaping information comprising a suggested in-band EVM lower than a current in-band EVM; and
adjust, based on the shaping information, the set of shaping parameters.

21. The apparatus of claim 20, wherein the shaping information further comprises multiple in-band errors and out-of-band errors respectively corresponding to multiple values of the set of shaping parameters.

22. The apparatus of claim 18, wherein the at least one processor is further configured to:
receive, from the network entity, an operational configuration including one or more of:
the operated MCS,
a selected length of a guard band associated with the resampling process, or
a selected set of shaping parameters,
wherein to process the input signal using the resampling process, the at least one processor is configured to:
process, based on the operational configuration, the input signal using the resampling process.

23. The apparatus of claim 18, wherein to process the input signal using the resampling process to obtain the processed signal, the at least one processor is configured to:
process the input signal using a first modulation order on a first region of a bandwidth of the LPF associated with the resampling process and a second modulation order on a second region of the bandwidth, wherein the second region is located closer to an edge of the bandwidth than the first region, and the second modulation order is lower than the first modulation order.

24. An apparatus for wireless communication at a network entity, comprising:
at least one memory; and
at least one processor coupled to the at least one memory and, based at least in part on information stored in the at least one memory, the at least one processor is configured to:
transmit, to a user equipment (UE), an indication of a requested value of an error vector magnitude (EVM) for a resampling process for an input signal at the UE;
communicate with the UE to identify a set of parameters associated with the resampling process; and
receive a processed signal, wherein the processed signal is processed based on the input signal using the resampling process.

25. The apparatus of claim 24, further comprising a transceiver coupled to the at least one processor, wherein to transmit the indication of the requested value of the EVM, the at least one processor is configured to transmit the indication of the requested value of the EVM via the transceiver, wherein the resampling process is associated with a single-carrier frequency division multiple access (SC-FDMA) transmission mechanism for communicating with the network entity, and wherein the at least one processor is further configured to:
transmit, to the UE, a reduced complexity request indicating a usage of the resampling process to replace a transformation process for the input signal; and
receive, from the UE, a confirmation response confirming the usage of the resampling process based on a UE capability supporting the resampling process.

26. The apparatus of claim 25, wherein the EVM is associated with a band error of the resampling process, and the requested value of the EVM is based on one or more of:
an operated modulation and coding scheme (MCS), or
a noise condition on an uplink channel.

27. The apparatus of claim 26, wherein the set of parameters includes:
a first length of a low-pass filter (LPF) associated with the resampling process,
a second length of a guard band associated with the resampling process, wherein the guard band is located between a cutoff frequency and an edge of a frequency domain allocation associated with the resampling process, and
a set of shaping parameters for the resampling process, wherein the set of shaping parameters is associated with an in-band EVM and an out-of-band EVM in the resampling process.

28. The apparatus of claim 27, wherein the at least one processor is further configured to:
transmit, to the UE, an operational configuration including one or more of:
the operated MCS,
a selected length of the guard band, or
a selected set of shaping parameters,
wherein the input signal is processed using the resampling process based on the operational configuration.

29. A method of wireless communication at a user equipment (UE), comprising:
receiving, from a network entity, an indication of a requested value of an error vector magnitude (EVM) for a resampling process for an input signal;
processing the input signal using the resampling process and a set of parameters to obtain a processed signal, wherein the set of parameters is based on the requested value of the EVM; and
communicating the processed signal with the network entity.

30. A method of wireless communication at a network entity, comprising:
transmitting, to a user equipment (UE), an indication of a requested value of an error vector magnitude (EVM) for a resampling process for an input signal at the UE;
communicating with the UE to identify a set of parameters associated with the resampling process; and
receiving a processed signal, wherein the processed signal is processed based on the input signal using the resampling process.
